(19) United States
(12) Patent Application Publication
(10) Pub. No.: US 2002/0129145 A1
(43) Pub. Date: Sep. 12, 2002

(54) Method and system for real-time querying, retrieval and integration of data from database over a computer network

(75) Inventor: Ey-Chih Chow, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Accelerate Software Inc., Cupertino, CA

(21) Appl. No.: 10/056,423

(22) Filed: Jan. 23, 2002

Related U.S. Application Data
(60) Provisional application No. 60/273,816, filed on Mar. 6, 2001.

(51) Int. Cl. G06F 15/173; G06F 15/16

(52) U.S. Cl. 709/225; 709/202

(57) ABSTRACT

A system for retrieving and integrating data from multiple databases over a computer network is provided. According to one aspect of the system, the system includes an agregation server and a number of agents. The aggregation server is capable of communicating with the agents via a computer network such as the Internet. Each agent is designed to communicate locally with a number of data sources. A user is able to retrieve data from the data sources by contacting the aggregation server which, in turn, causes the appropriate agents to retrieve the requested data from the relevant data sources.

### CROSS-REFERENCES TO RELATED APPLICATION(S)

The present application claims the benefit of priority under 35 U.S.C. § 119 from U.S. Provisional Patent Application Serial No. 60/273,816, entitled “METHOD AND SYSTEM FOR REAL-TIME QUERYING, RETRIEVAL AND INTEGRATION OF DATA FROM DATABASES OVER A COMPUTER NETWORK” filed on Mar. 6, 2001, the disclosure of which is hereby incorporated by reference in its entirety for all purposes.

### BACKGROUND OF THE INVENTION

The present invention generally relates to data retrieval. More specifically, the present invention relates to a method and system for retrieving and integrating data from one or more databases over a computer network.

As business-to-business (B2B) technology becomes more widespread, a number of companies have implemented B2B platforms, along the way defining protocols which allow for automated standardized interactions between some of their business partners. Most often, these protocols are designed to model the paper-based processes—orders, invoices, etc.—in an effort to more efficiently execute such processes and reduce the associated costs. The business objective was to lower operating costs.

The evolution of the Internet as a communication vehicle between businesses has allowed many companies to utilize business-to-business software platforms to link simple business processes and transactions with each other—orders, invoices, etc. However, this has still not enabled businesses within a value chain to truly collaborate and share information to allow business partners to make intelligent decisions about when, where and how to conduct these transactions.

B2B transaction automation, outside the firewall, tracks a similar pattern to the internal transaction automation companies implemented in the 1980s, and the e-commerce transaction automation implemented in the late 1990s. Different technologies were used—CICS with COBOL for internal business transactions, and e-commerce servers with Java for e-commerce. The same result occurred. Standard transactions and processes were captured and automated to save execution costs.

Simple transaction execution provides the first level of automation but does not wring all the costs out of the business processes involved. History has shown that once simple transactions were defined, the business problems evolved to require more complex decision-making and intelligence.

Today's computer networking environments and technologies, such as the electronic data interchange (EDI), email and ftp, are conventionally used by enterprises to share information across a business supply chain for forecasting, planning and execution. However, when information must be collected and generated in short periods of time such as on an hourly basis or even real time, these technologies often perform below expectations.

Various systems were introduced in an attempt to improve the above-mentioned situation. For example, one system was introduced to solve planning issues such as retailer forecasting and inventory management by connecting retailers' and suppliers' resources through direct connection of their computers through networking. The forecasting is calculated by doing a serious of reviews on an order in a basically single-to-single enterprise basis.

Another example is a system that allows data access outside a single enterprise. The interchange layer of the system allows the system to see the whole supply chain instead of a single enterprise, which is mostly beneficial to supply chain planning. Data from the supply chain is collected and stored on the database. The data is then processed using certain parameters and processes to provide supply information for supply chain planning. Basically, using certain parameters such as manufacturing capacity, ERP and financial support, a forecasting module can be set up to evaluate information that is necessary for supply chain planning. Data is collected and then computed before it is accessible for planning. The system is designed to shorten the time to collect and compute a large variety and amount of data. It is useful for forecasting and planning purpose. However, the system only allows for access of computed data that can be computed with a certain amount of time delay. It cannot provide up-to-date and accurate data to support the supply chain real time decision-making. When a specific piece of data is required by the user that is out of the syllabus of the forecasting model, the computed data also lacks flexibility to fulfill the requirement.

Therefore, it would be desirable to provide a method and system which is capable of querying, retrieving and integrating data from databases over a computer network on a real-time basis in a more efficient manner.

### SUMMARY OF THE INVENTION

A method and system for retrieving and integrating data from multiple databases over a computer network is provided. An exemplary embodiment of the present invention includes a system having an agregation server and a number of agents. The aggregation server is capable of communicating with the agents via a computer network such as the Internet. Each agent is designed to communicate locally with a number of data sources. A user is able to retrieve data from the data sources by contacting the aggregation server which, in turn, causes the appropriate agents to retrieve the requested data from the relevant data sources.

According to an exemplary embodiment, when the user issues a request to the aggregation server to retrieve certain data, the request is converted into an internal query by the aggregation server. The internal query is then matched against a set of rules. Each rule specifies how an internal query is to be partially satisfied using one or more data sources. For a set of rules matching the internal query, a subquery is generated. All the generated subqueries of the internal query are then used by their respective agents to retrieve the requested data. Optionally, all the generated subqueries are optimized to effect more efficient retrieval of data from the respective data sources. When the requested data is returned from all the relevant agents, the requested data is then joined, fused and unioned to produce the final results representing the collective data responsive to the internal query. Star union is used to optimize the union and join operations.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating an exemplary embodiment of the present invention;

FIG. 2 is a flow diagram illustrating the data integration process performed by an exemplary embodiment of the present invention;

FIG. 3 is an illustrative example of an input query request in accordance with an exemplary embodiment of the present invention;

FIG. 4 is an illustrative example of a query definition file in accordance with an exemplary embodiment of the present invention;

FIG. 5 is an illustrative example of a mediator specification file in accordance with an exemplary embodiment of the present invention;

FIG. 6 is an illustrative example of an agent capability file in accordance with an exemplary embodiment of the present invention; and

FIGS. 7a and 7b are illustrative examples of a query mapping file in accordance with an exemplary embodiment of the present invention.

### DETAILED DESCRIPTION OF THE INVENTION

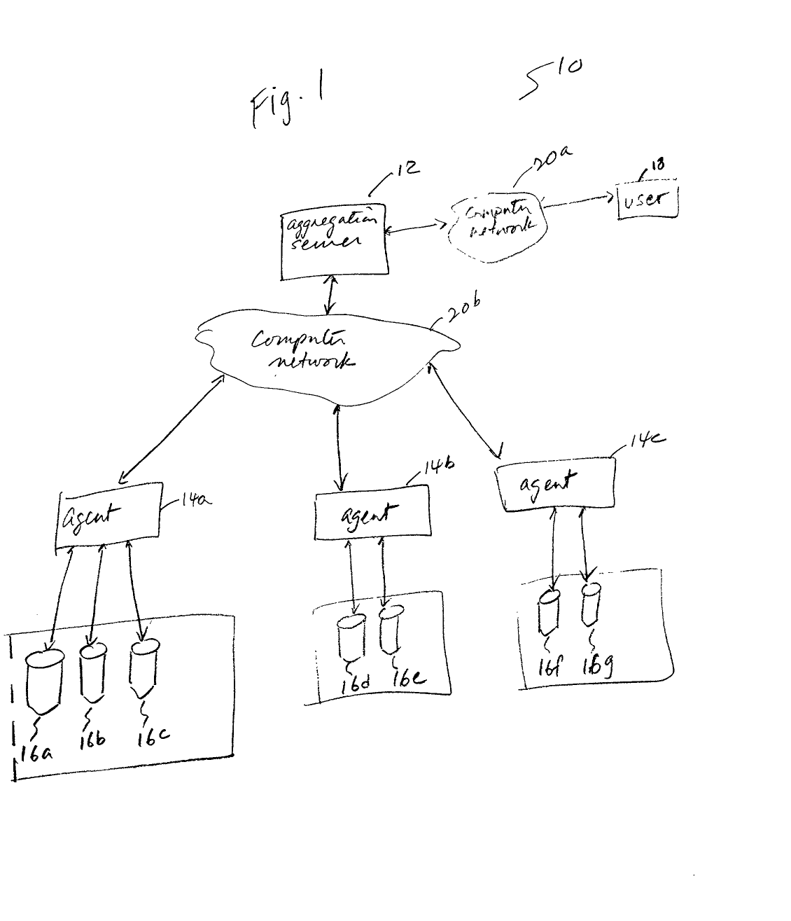

The present invention in the form of one or more exemplary embodiments will now be described. FIG. 1 is a simplified block diagram illustrating an exemplary embodiment of the present invention. Referring to FIG. 1, there is a shown a system 10 representing an exemplary embodiment of the present invention. The system 10 includes an aggregation server 12, a number of agents 14, and a number of data sources 16. The data sources 16 include, for example, databases and applications which is capable of supplying data. The data sources 16 are generally organized into groups based on one or more predetermined criteria. For example, data sources 16a-c may be grouped together because these data sources 16a-c reside on a single computer system belonging to the same company. However, it should be understood that the data sources 16 need not reside on a single computer system. A person of ordinary skill in the art will know of other ways to organize a group of data sources. Moreover, each of the data sources 16 within a group may be different. For instance, within a group, one data source may be a database manufactured by one vendor, such as, IBM, and another data source may be a database from a second vendor, such as, Oracle. Each agent is designed to communicate with a specific group of data sources 16 to retrieve and integrate the desired or requested data.

The system 10 generally operates in the following exemplary manner. When a user 18 wishes to retrieve certain data, the user 18 issues a request to the aggregation server 12. In an exemplary embodiment, the user 18 uses a graphical user interface on a computer to relay the request to the aggregation server 12 via a computer network 20a, such as, the Internet. The request is encoded in XML format for delivery from the user 18 to the aggregation server 12. In an alternative embodiment, the user 18 may interact directly with the aggregation server 12 without going through any computer network.

Upon receiving the request, the aggregation server 12 processes the request and determines which one or more of the agents 14 have access to the requested data. Upon identifying these agents 14, the aggregation server 12 communicates with these agents 14 via a computer network 20b to retrieve the requested data. This computer network 20b can also be, for example, the Internet. Hence, the computer networks 20a,b may or may not be the same.

Each identified agent 14 further processes the request received from the aggregation server 12 and accesses the appropriate data sources 16 to retrieve the requested data. The agent 14 then integrates the retrieved data and forwards it to the aggregation server 12. The integrated data can be formatted in XML or SOAP and then forwarded to the aggregation server 12 via the computer network 20b using a number of transfer protocols including, for example, HTTP. Based on the disclosure provided herein, a person of ordinary skill in the art will know of other formats and transfer protocols which can be used to implement the data transfer between the agent 14 and the aggregation server 12.

Upon receiving the retrieved data from all the relevant agents 14, the aggregation server 12 then integrates all the retrieved data and presents it to the user 18. Details with respect to how each agent 14 and the aggregation server 12 retrieves and integrates the requested data will be described further below.

The operation of the system 10 is further illustrated in a more practical context as follows. In one exemplary configuration, an agent 14 resides on the private computer network of a company and is able to communicate locally with that company's internal data sources, such as, databases and applications. When a customer of the company wishes to obtain certain information relating to, for example, his/her purchase order, the customer issues a request to the aggregation server 12. The request is processed and then relayed by the aggregation server 12 to the agent 14 via, for example, the Intranet. The agent 14, in turn, retrieves the requested information from the company's data sources and then integrates the retrieved information for delivery to the aggregation server 12 which subsequently forwards the information to the customer.

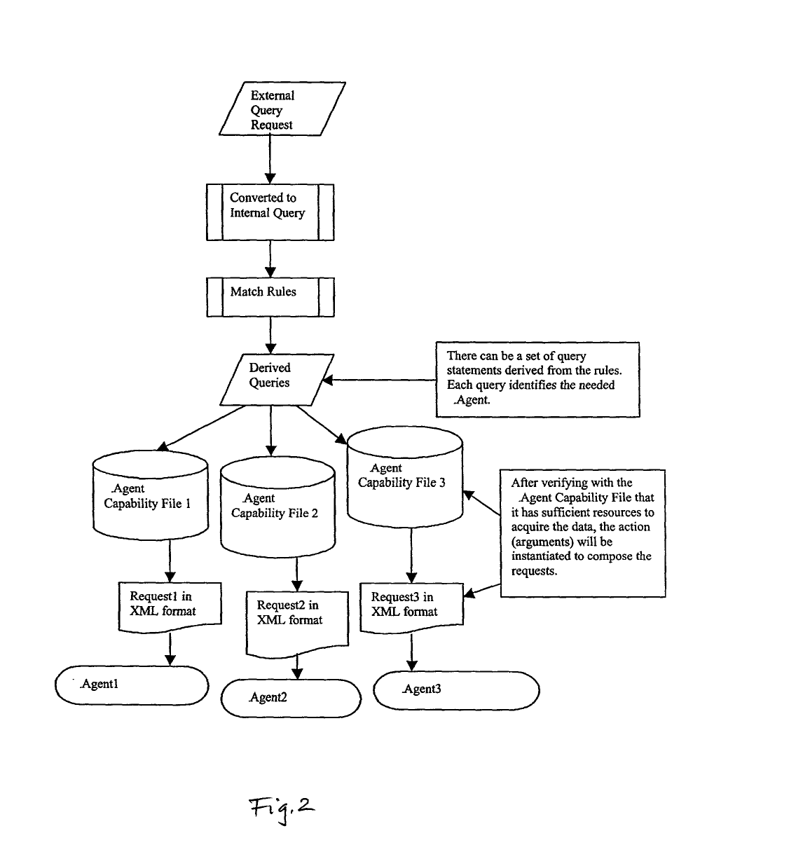

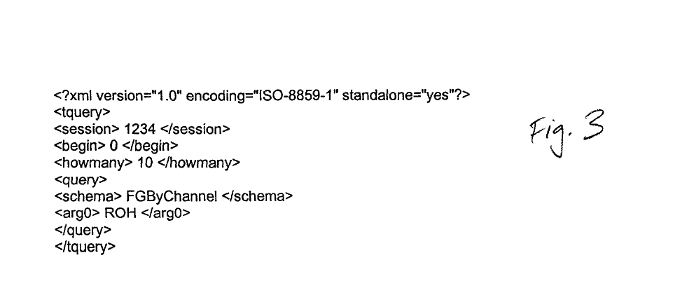

FIG. 2 is a flow diagram illustrating in further detail how a request issued by the user 18 is processed so as to cause one or more agents 14 to retrieve and integrate the requested data. Referring to FIG. 2, the user 18 uses a request form or a graphical user interface to enter the request for data. The request form contains a number of different fields. Different request forms may be available to the user 18 to request different types of data. In an exemplary embodiment, the request form (and the information contained therein) is converted into an input query request encoded in XML format for delivery to the aggregation server 12. FIG. 3 shows an illustrative example of the input query request.

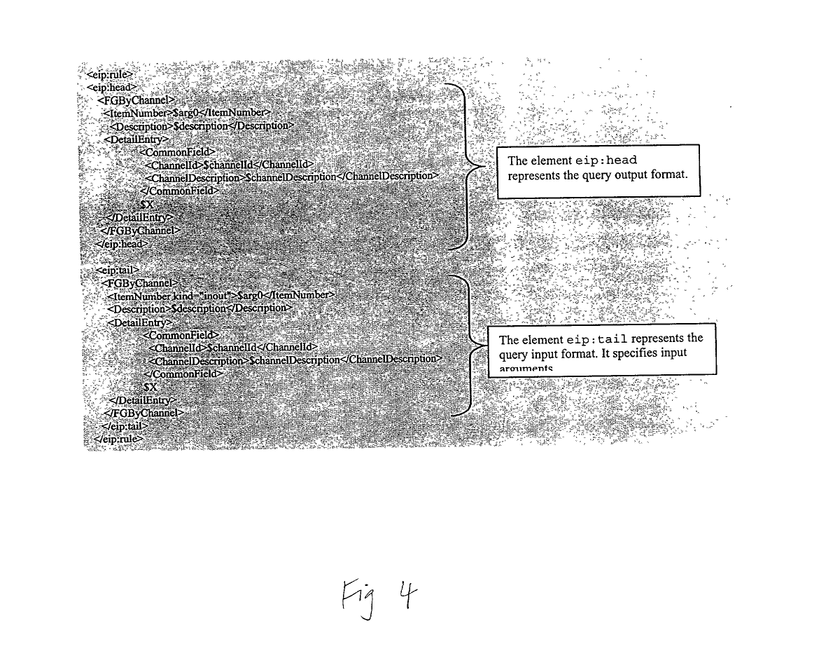

Upon receiving the input query request from the user 18, the aggregation server 12 breaks down or converts the input query request into an internal query. In particular, for each input query request , there is a corresponding request template that can be instantiated to the internal query. The internal query is represented by a query definition file. The query definition file has two parts, namely, a head portion and a tail portion. The head portion represents the query output format, i.e., it describes what data structure is going to be displayed and the way data fusion is going to take place when data responsive to the internal query is retrieved. The tail portion represents the query input formats, i.e., it specifies what kind of data is to be retrieved and the requisite input arguments or parameters needed to retrieve such data. The tail portion is made up of a conjunctive set of query input formats. FIG. 4 provides an illustrative example of the query definition file. The purpose and use of the query definition file will be further described below.

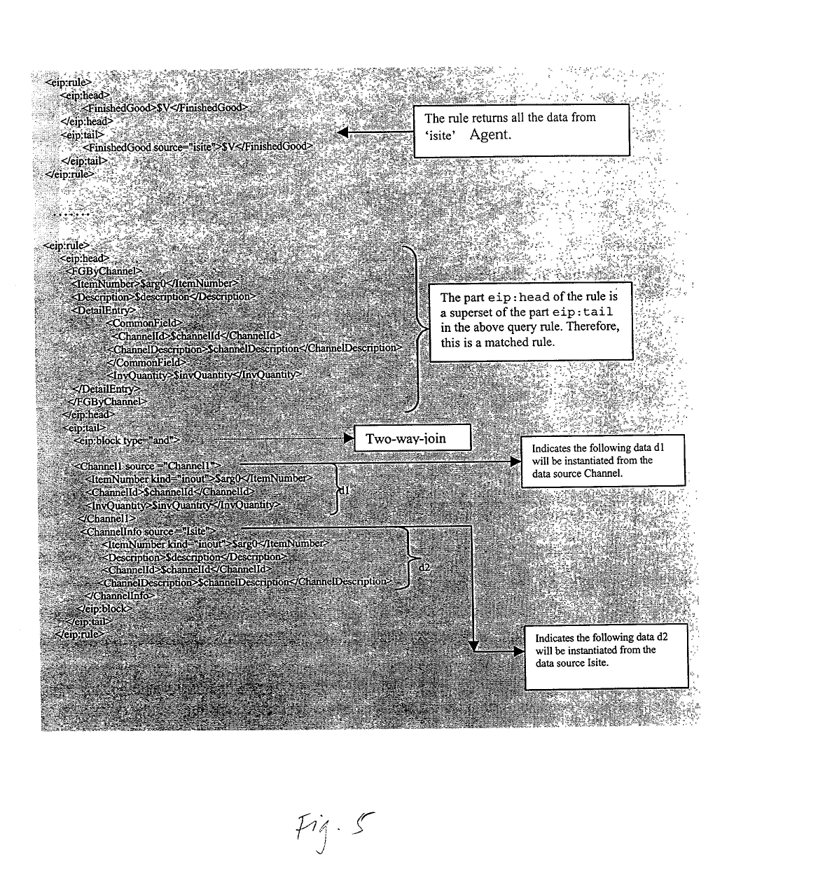

Once the internal query (and the corresponding query definition file) is created, the internal query is evaluated against a set of rules. This set of rules specifies where and how different internal queries are to be satisfied. For example, one rule may specify that a specific internal query can be satisfied by a first and a second data source; another rule may specify that this same specific internal query can also be satisfied by a third and a fourth data source. More generally, a rule can specify how a subset of the conjunctive set of query input formats in the tail portion of the internal query can be satisfied. A combined set of rules can then be used to specify how the entire internal query can be satisfied. The set of rules are designed based on the structures, constraints and contents of the data sources. In an exemplary embodiment, this set of rules is stored in a mediator specification file residing on the aggregation server 12. Each rule in the mediator specification file also includes a head portion. Similar to the tail portion of the query definition file, the head portions of the set of rules in the mediator specification file also represent the query input formats, i.e., it specifies what kind of data is to be retrieved and the requisite input arguments or parameters needed to retrieve such data. The use of this similar functionality will be further explained below. FIG. 5 provides an illustrative example of the mediator specification file.

Referring back to FIG. 2, the internal query is evaluated against each rule within the set of rules in the mediator specification file. More specifically, the corresponding query definition file for the internal query is examined to determine if the tail portion of the query definition file matches a set of the head portions of rules within the mediator specification file. In other words, if each of the input query formats of the tail portion of the query definition file is matched with the head portion of one rule within the set of rules, then that set of rules is considered to be a match with the internal query. It should be noted that for a rule to be considered a match with a subset of input query formats of the tail portion of the query definition file, the subset of input query formats of the tail portion of the query definition file does not have to be identical to the head portion of the rule in the mediator specification file. It is sufficient to be considered a match if the subset of input query formats of the tail portion of the query definition file is equal to part or all of the head portion of the rule. In other words, the head portion of the rule may be a superset of the tail portion of the query definition file; conversely, the tail portion of the query definition file may be a superset of the head portion of the rule.

For each set of matched rules, the aggregation server 12 generates a subquery. For each internal query, one or more subqueries may be generated. Each subquery identifies the data sources that are used to supply data which are responsive to the internal query as well as the agent 14 that is designed to access those identified data sources. Optionally, as will be further described below, the aggregation server 12 analyzes the subqueries and formulates a query execution plan to optimize the execution of the subqueries by the relevant agents 14.

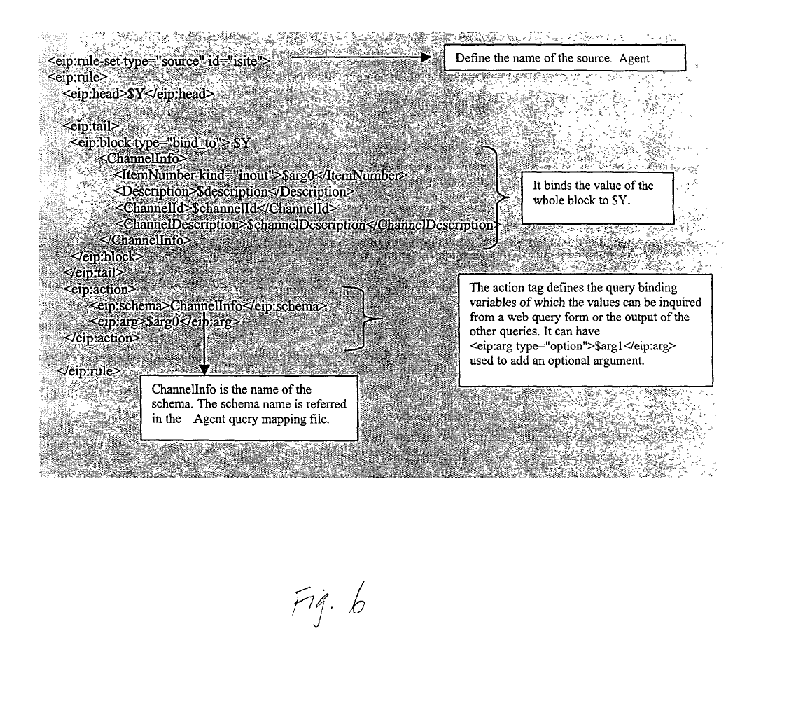

For each subquery, the aggregation server 12 determines if the subquery can be executed with a set of agents. The set of agents may include one or more agents. All the relevant agents 14 are then identified from the subqueries. Each agent has a corresponding agent capability file. FIG. 6 provides an illustrative example of an agent capability file. The corresponding agent capability file for each relevant agent is checked to determine if that particular agent is capable of returning the data specified by the associated subquery. A particular agent may not be able to participate in executing the associated subquery due to a number of factors.

If it is determined that a relevant agent is capable of participating in executing the associated subquery, the associated subquery is then formatted appropriately into an agent request and transmitted to the relevant agents for execution. In an exemplary embodiment, the aggregation server 12 encodes the associated subquery into the agent requests in XML format and forwards it to the relevant agents via the Internet.

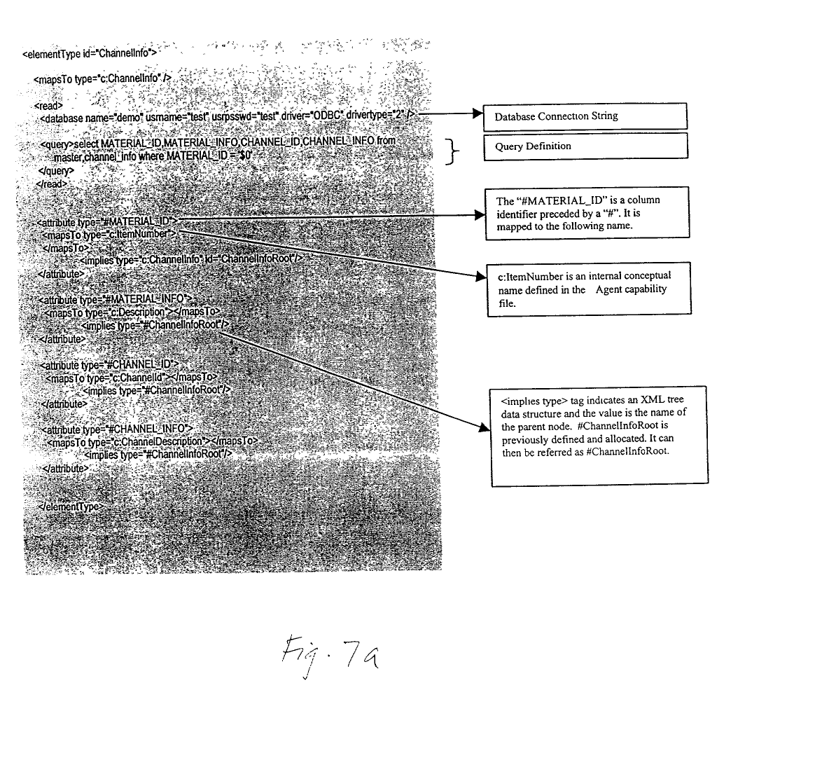

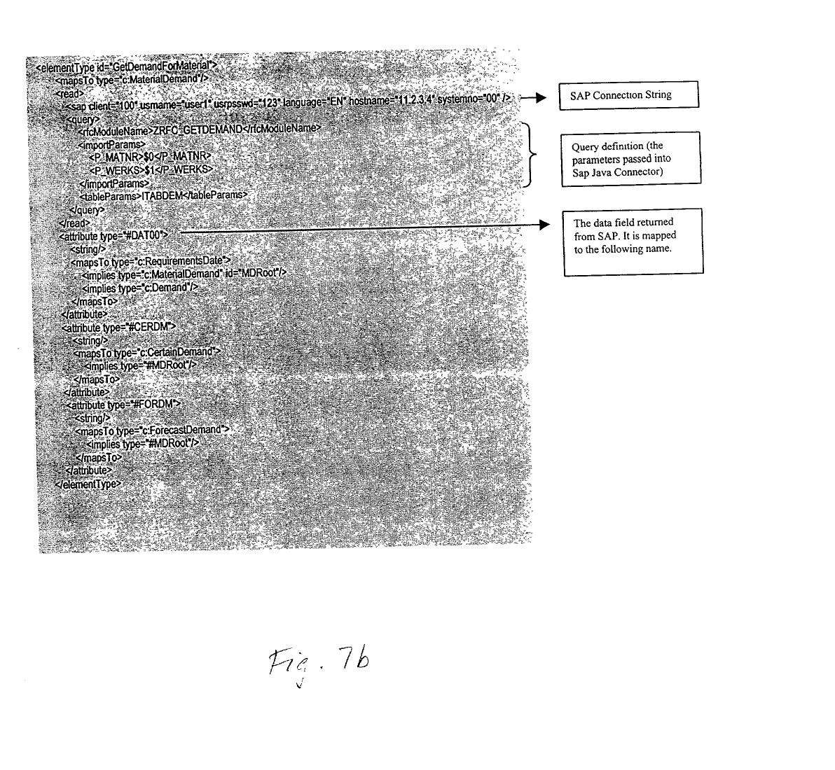

Upon receiving the agent requests which embody the subquery, each of the relevant agents then identifies a query mapping file which corresponds to the received agent request. The query mapping file is used to map information between data in a desired format and native data retrieved from the data sources pursuant to the subquery. Furthermore, the query mapping file also includes information on how to connect to a data source thereby allowing the relevant agent to access the data source. For example, one data source to be accessed may be a database and another data source may be an application which communicates via an application programming interface. FIGS. 7a and 7b provide illustrative examples of the query mapping file.

For each subquery embodied in a set of agent requests, i.e., at the agent level, data which is responsive to the subquery is retrieved by the set of relevant agents from the relevant data sources. Each agent then performs join operations on the retrieved data and encodes the joined data in the appropriate format for delivery to the aggregation server 12. In an exemplary embodiment, the joined data is encoded in the XML format.

Upon receiving the data from the relevant agents which executed the subqueries, the aggregation server 12 performs join, fusion and union operations on all the received data. The fusion operation aggregates data from different agents based on a set of attribute values defined in the head portion of the query definition file. The union operation unions together all aggregated data returned by the relevant agents.

It should be noted that the volume of data which is responsive to the internal query may be quite high and, due to system constraints and/or other requirements, all the responsive data may not be retrieved by the relevant agents or processed by the aggregation server 12 all at once. Therefore, the amount of responsive data which is to be retrieved by the relevant agents and/or processed by the aggregation server 12 at any one time is configurable.

As mentioned above, the aggregation server 12 can also analyze the subqueries and formulate a query execution plan to optimize the execution of the subqueries by the relevant agents 14. Take, for example, an internal query that has three sets of matched rules thereby generating three subqueries. The three subqueries are the same except that they each require access to different combinations of data sources. For instance, the first subquery specifies that data source A and data source B are to be accessed; the second subquery specifies that data source A and data source C are to be accessed; and the third subquery specifies that data source A and data source D are to be accessed. Without any optimization, the agent requests corresponding to the subqueries are executed by their respective agents independently. Consequently, data source A is accessed three times.

Optionally, the aggregation server 12 may optimize the execution of the subqueries as follows. First, the common data source shared by the subqueries is identified. A common key shared by all the data sources accessed by the subqueries is also identified. Then, the first subquery is executed against the common data source to retrieve, amongst other data, a list of possible values for the common key. The list of retrieved values for the common key is then concurrently passed to the relevant agents to be used to access the other data sources pursuant to the subqueries. The results retrieved pursuant to the subqueries are then unioned together to generate the final, appropriate results. This overall union operation is called star union.

The foregoing optimization process is illustrated using the example given above. Furthermore, assume in the example that data source A is used to store information on component parts and their respective descriptions. The information is indexed or keyed by one field, part number. Data sources B, C and D are used to store information on component parts and their respective quantities for suppliers B, C and D. The information is indexed or keyed by one field, part number. Using the foregoing optimization process as described above, the common data source shared by the three subsqueries is data source A. The common key shared by data sources A, B, C and D is the part number field. Using this information, the first subquery is executed against data source A and a list of values indexed by the part number field is retrieved. This list of values represents the part number information requested by the first subquery. This list of values is then used to retrieve the relevant information from each of the remaining data sources B, C and D pursuant to the respective subqueries. The data retrieval from the data sources B, C and D can be done in a concurrent manner. Pursuant to the first subquery (which specifies access to data sources A and B), the results retrieved from data source A are then joined with results retrieved from data source B. The joined results represent information related to selected component parts, their respective descriptions and quantities which are available from supplier B. Similarly, pursuant to the second subquery (which specifies access to data sources A and C), the results retrieved from data source A are then joined with results retrieved from data source C. The joined results represent information related to selected component parts, their respective descriptions and quantities which are available from supplier C. Likewise, pursuant to the third subquery (which specifies access to data sources A and D), the results retrieved from data source A are then joined with results retrieved from data source D. The joined results represent information related to selected component parts, their respective descriptions and quantities which are available from supplier D. All the respective joined results are then fused together so that for each part number, the data retrieved from data sources B, C and D are aggregated together in the final results which satisfy the internal query.

In an exemplary embodiment, the present invention is implemented in the form of control logic in either a modular or integrated manner using software. Based on the disclosure provided herein, however, it will be appreciated by a person of ordinary skill in the art that the present invention can also implemented using other methods and/or techniques, such as, hardware implementation and a combination of software and hardware implementation.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for retrieving and integrating data from a plurality of data sources, comprising:
an aggregation server configured to convert a data request into an internal query and generate one or more subqueries from the internal query by matching the internal query against a set of rules; and
one or more agents, each agent configured to communicate with one or more data sources and retrieve data from the one or more data sources pursuant to an associated subquery provided by the aggregation server;
wherein the aggregation server is further configured to join, fuse and union respective data retrieved by the one or more agents; and
wherein the one or more agents are located at respective remote locations and the aggregation server communicates with the one or more agents via a computer network.

2. The system of claim 1 wherein:
the internal query is represented by a query definition file having a head portion and a tail portion;
the set of rules is represented by a mediator specification file, each rule within the mediator specification file having a head portion and specifying how one of a plurality of internal queries is satisfied by one or more of the plurality of data sources;
a subset of rules within the set of rules is considered to be a match with the internal query if the tail portion of the query definition file matches the combined set of head portions of the subset of rules; and
for each set of matched rules, the aggregation server generates a corresponding subquery.

3. The system of claim 1 wherein each agent has a corresponding agent capability file; and
wherein the aggregation server is further configured to check the corresponding agent capability file of an agent before the agent is invoked to retrieve data from one or more data sources pursuant to an associated subquery provided by the aggregation server.

4. The system of claim 1 wherein upon receiving the associated subquery provided by the aggregation server, an agent uses a query mapping file which corresponds to the associated subquery to enable the one or more data sources to be accessed.

5. The system of claim 1 wherein the aggregation server formulates a query execution plan using the one or more subqueries generated from the the internal query; and
wherein the one or more subqueries are executed by their respective agents pursuant to the query execution plan to optimize access to the one or more data sources.

6. The system of claim 1 wherein the computer network is the Internet.

7. The system of claim 1 wherein the plurality of data sources includes a database or an application.

8. The system of claim 1 wherein the aggregation server and the one or more agents are implemented using software, hardware or a combination of both.

9. The system of claim 1 wherein communications between the aggregation server and the one or more agents are encoded in XML format.

10. A system for retrieving and integrating data from a plurality of data sources over a computer network, comprising:
an aggregation server configured to receive a data request from a user and convert the data request into an internal query, the aggregation server further configured to match the internal query against a set of rules and, for each matched rule, generate a corresponding subquery; and
a plurality of agents, one or more agents forming a set of agents configured to communicate with one or more data sources and retrieve data from the one or more data sources pursuant to a corresponding subquery provided by the aggregation server;
wherein the aggregation server is further configured to union respective data retrieved by one or more of the plurality of agents; and
wherein the plurality of agents are located at respective remote locations and the aggregation server communicates with the plurality of agents via the computer network.

11. The system of claim 10 wherein:
the internal query is represented by a query definition file having a head portion and a tail portion;
the set of rules is represented by a mediator specification file, each rule within the mediator specification file having a head portion and specifying how one of a plurality of internal queries is satisfied by one or more of the plurality of data sources; and
a subset of rules within the set of rules is considered to be a match with the internal query if the tail portion of the query definition file matches the combined head portions of the subset of rules.

12. The system of claim 10 wherein each agent has a corresponding agent capability file; and
wherein the aggregation server is further configured to check the corresponding agent capability file of an agent before the agent is invoked to retrieve data from one or more data sources pursuant to the corresponding subquery provided by the aggregation server.

13. The system of claim 10 wherein upon receiving the corresponding subquery provided by the aggregation server, an agent uses a query mapping file which maps the corresponding subquery to enable the one or more data sources to be accessed.

14. The system of claim 10 wherein the aggregation server formulates a query execution plan using the one or more subqueries generated from the the internal query; and
wherein the one or more subqueries are executed by their respective sets of agents pursuant to the query execution plan to optimize access to the one or more data sources.

15. The system of claim 14 wherein the aggregation server formulates the query execution plan by identifying a common data source to be accessed pursuant to the one or more subqueries and a common key shared by respective data sources to be accessed pursuant to the one or more subqueries.

16. The system of claim 10 wherein the computer network is the Internet.

17. The system of claim 10 wherein the plurality of data sources includes a database or an application.

18. The system of claim 10 wherein the aggregation server and the plurality of agents are implemented using software, hardware or a combination of both.

19. The system of claim 10 wherein communications between the aggregation server and the plurality of agents are encoded in XML format.

20. A system for retrieving and integrating data via a computer network, comprising:
an aggregation server configured to include a query definition file generated from a data request, the query definition file having a head portion and a tail portion, a mediator specification file having a plurality of rules, each rule having a head portion, and a plurality of agent capability files;
a plurality of data sources; and
a plurality of agents, each agent configured to retrieve data from one or more of the plurality of data sources and having a corresponding query mapping file;
wherein:
the aggregation server maintains an agent capability file for each agent;
the aggregation server matches the query definition file against the plurality of rules;
a set of rules is considered to be a match if the tail portion of the query definition file matches the corresponding head portion of the rule;
for each matched rule, the aggregation server generates a corresponding subquery, the subquery including information on a set of specific agents to be invoked;
for the specific agents to be invoked, the aggregation server checks the corresponding agent capability files to determine if the specific agents are capable of handling the corresponding subqueries;
for specific agents that are determined to be capable of handling their corresponding subqueries, each such specific agent is caused to retrieve data from one or more of the plurality of data sources using its corresponding query mapping file; and
upon receiving the retrieved data from the specific agents, the aggregation server performs join, fusion and union operations on the retrieved data.

21. The system of claim 20 wherein the aggregation server formulates a query execution plan using the corresponding subqueries; and
wherein the corresponding subqueries are executed by their respective sets of specific agents pursuant to the query execution plan to optimize access to the one or more data sources.

22. The system of claim 21 wherein the aggregation server formulates the query execution plan by identifying a common data source to be accessed pursuant to the corresponding subqueries and a common key shared by respective data sources to be accessed pursuant to the corresponding subqueries.

23. The system of claim 20 wherein the computer network is the Internet.

24. The system of claim 20 wherein the plurality of data sources includes a database or an application.

25. The system of claim 20 wherein the aggregation server and the plurality of agents are implemented using software, hardware or a combination of both.

26. The system of claim 20 wherein communications between the aggregation server and the plurality of agents are encoded in XML format.

27. A method for using an aggregation server and a plurality of agents to retrieve and integrate data from a plurality of data sources via a computer network, comprising:
configuring the aggregation server to perform the following:
receiving a data request from a user;
converting the data requesting into an internal query;
matching the internal query against a plurality of rules;
for each set of matched rules, generating a corresponding subquery for an agent;
forwarding information relating to all generated subqueries to their respective sets of agents;
performing join, fusion and union operations on data returned from the respective sets of agents; and
configuring each of the plurality of agents to perform the following:
receiving information to the corresponding subquery from the aggregation server;
retrieving data pursuant to the corresponding subquery from one or more of the plurality of data sources; and
returning the retrieved data to the aggregation server.

28. The method of claim 27 wherein the step of configuring the aggregation server further comprises:
formulating a query execution plan using all the generated subqueries; and
forwarding information relating to all the generated subqueries to their respective sets of agents pursuant to the query execution plan.

29. The method of claim 28 wherein the step of formulating the query execution plan further comprises:
identifying a common data source to be accessed pursuant to the generated subqueries and a common key shared by respective data sources to be accessed pursuant to the generated subqueries.

30. The method of claim 27 wherein the step of configuring the aggregation server further comprises:
before forwarding information relating to all generated subqueries to their respective sets of agents, checking each respective agent to determine if such agent is capable of handling the corresponding subquery.

31. The method of claim 27 wherein the computer network is the Internet.

32. The method of claim 27 wherein the plurality of data sources includes a database or an application.

33. The method of claim 27 wherein the method is implemented using software, hardware or a combination of both.

34. A method for using an aggregation server and a plurality of agents to retrieve and integrate data from a plurality of data sources via a computer network, comprising:
instructing the aggregation server to generate a query definition file from a data request, the query definition file having a head portion and a tail portion;
instructing the aggregation server to match the query definition file against a mediator specification file having a plurality of rules, each rule having a head portion, a set of rules is considered to be a match if the tail portion of the query definition file matches the corresponding combined head portions of the rules in the set;
for each set of matched rules, instructing the aggregation server to generate a corresponding subquery, the subquery including information on a specific set of agents to be invoked;
for the specific set of agents to be invoked, instructing the aggregation server to check corresponding agent capability files to determine if each of the specific set of agents is capable of handling the corresponding subqueries;
for specific agents that are determined to be capable of handling their corresponding subqueries, instructing each such specific agent to retrieve data from one or more of the plurality of data sources using a corresponding query mapping file and return the retrieve data to the aggregation server; and
upon receiving the returned data from the specific agents, instructing the aggregation server to perform join, fusion and union operations on the returned data.

35. The method of claim 34 further comprising:
instructing the aggregation server to formulate a query execution plan using the corresponding subqueries; and
instructing the aggregation server to cause the corresponding subqueries to be executed by their respective specific sets of agents pursuant to the query execution plan to optimize access to the one or more data sources.

36. The method of claim 35 wherein the step of instructing the aggregation server to formulate the query execution plan further comprises:
identifying a common data source to be accessed pursuant to the corresponding subqueries and a common key shared by respective data sources to be accessed pursuant to the corresponding subqueries.
